(19) United States
(12) Patent Application Publication
(10) Pub. No.: US 2008/0234331 A1
(43) Pub. Date: Sep. 25, 2008

(54) Synergistic Insecticidal Mixtures for the Treatment of Seed

(75) Inventors: Klaus Fellmann, Leverkusen (DE); Bernd Springer, Koln (DE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Bayer CropScience AG, Monheim (DE)

(21) Appl. No.: 12/093,299

(22) PCT Filed: Oct. 30, 2006
(86) PCT No.: PCT/EP06/10404

§ 371 Date: May 9, 2008

(30) Foreign Application Priority Data
Nov. 10, 2005 (DE) 10 2005 053 680.8

(51) Int. Cl. A01N 43/40; A01N 37/18; A01N 51/00; A01N 25/26; A01P 7/04; A01P 21/00

(52) U.S. Cl. 514/341; 514/365; 514/357; 514/471; 504/100; 504/130

(57) ABSTRACT

The invention relates to insecticidal mixtures containing, as active substances, at least two compounds from the series of the chloronicotinyl insecticides, and to the use of these mixtures for promoting plant growth.

The present invention relates to the treatment of seed with combinations of at least two chloronicotinyl insecticides, which leads to better growth of the plant and to higher yields.

It has already been disclosed that chloronicotinyl insecticides can be employed for controlling animal pests, in particular insects. The chloronicotinyl insecticides include the following compounds:

imidacloprid, of the formula (I),

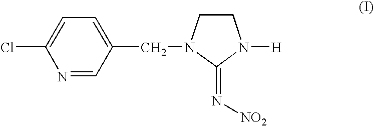

(cf. EP 0 192 060)
clothianidin, of the formula (II),

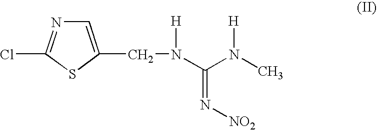

### (EP 0 376 279)

dinotefuran, of the formula (III),

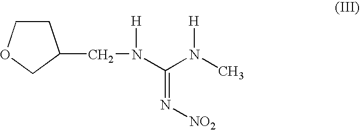

### (EP 0 649 845)

thiamethoxam, of the formula (IV),

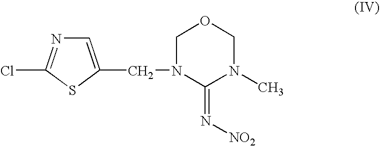

### (EP 0 580 553)

thiacloprid, of the formula (V),

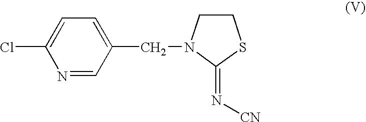

### (EP 0 235 725)

acetamiprid, of the formula (VI),

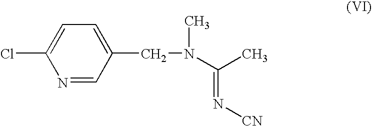

### (WO 91/04965)

nitenpyram, of the formula (VII),

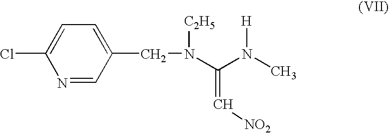

### (EP 0 302 389)

It has furthermore been disclosed that mixtures comprising in each case at least two and in particular precisely two compounds from the series of the chloronicotinyl insecticides, in particular of the formulae (I) to (VII), are synergistically active and are suitable for controlling animal pests. As a result of this synergism, it is possible to use markedly lower active substance quantities, i.e. the effect of the mixture exceeds the effect of the individual components (WO 2005/036966 A1).

It has furthermore been disclosed that individual chloronicotinyl insecticides have growth-promoting properties (WO 01/26468 A2).

It has now been found that compositions of mixtures comprising in each case at least two and in particular precisely two compounds from the series of the chloronicotinyl insecticides, in particular of the formulae (I) and (II), have, surprisingly, a synergistic effect on plant growth when the seed is treated with these active substances or active substance combinations. This increased plant growth results in higher yields and is therefore an economic advantage.

The amount to be employed of the mixing partners depends on the species of the crop plant and can be varied within a wide range. The optimal ratios and total application rates can be determined for each application by test series.

The following preferred mixtures according to the invention for the treatment of seed may be mentioned specifically:

TABLE

| | | | Preferred | Particularly |
|---|---|---|---|---|
| Mixture | First active | Second active | mixing | preferred |
| No. | substance | substance | ratio | mixing ratio |
| 1 | imidacloprid | clothianidin | 100:1-1:100 | 10:1-1:10 |
| 2 | imidacloprid | dinotefuran | ″ | ″ |
| 3 | imidacloprid | thiamethoxam | ″ | ″ |
| 4 | imidacloprid | thiacloprid | ″ | ″ |
| 5 | imidacloprid | acetamiprid | ″ | ″ |
| 6 | imidacloprid | nitenpyram | ″ | ″ |
| 7 | clothianidin | dinotefuran | ″ | ″ |
| 8 | clothianidin | thiamethoxam | ″ | ″ |
| 9 | clothianidin | thiacloprid | ″ | ″ |
| 10 | clothianidin | acetamiprid | ″ | ″ |
| 11 | clothianidin | nitenpyram | ″ | ″ |
| 12 | dinotefuran | thiamethoxam | ″ | ″ |
| 13 | dinotefuran | thiacloprid | ″ | ″ |
| 14 | dinotefuran | acetamiprid | ″ | ″ |
| 15 | dinotefuran | nitenpyram | ″ | ″ |
| 16 | thiamethoxam | thiacloprid | ″ | ″ |
| 17 | thiamethoxam | acetamiprid | ″ | ″ |
| 18 | thiamethoxam | nitenpyram | ″ | ″ |
| 19 | thiacloprid | acetamiprid | ″ | ″ |
| 20 | thiacloprid | nitenpyram | ″ | ″ |
| 21 | acetamiprid | nitenpyram | ″ | ″ |

Especially preferred are the mixtures 1 and 3. Very especially preferred is the mixture 1.

The mixtures according to the invention are also suitable for the treatment of seed. Thus, a large proportion of the damage to crop plants which is caused by pests is already generated by infestation while the seed is stored and after the seed is introduced into the soil, and during and immediately after germination of the plants. This phase is particularly critical since the roots and shoots of the growing plant are particularly sensitive and even a small amount of damage can lead to the death of the whole plant. There is therefore in particular a great interest in protecting the seed and the germinating plant by using suitable compositions.

Pests which damage plants after emergence are mainly controlled by treating the soil and the aerial plant parts with plant protection compositions. Concern regarding the potential effect of the plant protection compositions on the environment and the health of humans and animals have led to attempts to reduce the amount of the active substances applied.

The control of pests by treating the seed of plants has been known for a long time and is the subject of continuous improvement. However, the treatment of seed poses a series of problems which cannot always be solved in a satisfactory manner. Thus, it is desirable to develop methods of protecting the seed and the germinating plant which dispense with the additional application of plant protection compositions after sowing or after the emergence of the plants. It is furthermore desirable to optimize the amount of the active substance employed in such a way as to provide the best possible protection for the seed and the germinating plant against attack by pests without, however, damaging the plant itself by the active substance employed. In particular, methods for the treatment of seed should also include the intrinsic insecticidal properties of transgenic plants in order to achieve an optimal protection of the seed and of the germinating plant while keeping the application rate of plant protection compositions as low as possible.

Besides controlling insects, it is furthermore desirable to increase the yields of the crop plants. The present invention therefore in particular also relates to a method of increasing the yields of crop plants by treating the seed with a composition according to the invention.

The invention also relates to the use of the compositions according to the invention for the treatment of seed for the purposes of protecting the seed and the germinating plant against pests.

Furthermore, the invention relates to seed which has been treated with a composition according to the invention for the purposes of protecting it against pests.

One of the advantages of the present invention is that the plants are not only protected against infestation with insects, but also produce markedly higher yields.

Another advantage is that the mixtures according to the invention can also be employed in particular for transgenic seed.

The compositions according to the invention are suitable for the treatment of seed of any plant variety which is employed in agriculture, in the greenhouse, in afforestations, in horticulture or in viticulture. In particular, this takes the form of seed of maize, peanut, canola, oilseed rape, poppy, olive, coconut, cocoa, soya, cotton, beet (for example sugar beet and fodder beet), rice, sorghum and millet, wheat, barley, oats, rye, sunflower, sugar cane or tobacco. The compositions according to the invention are also suitable for the treatment of the seed of various vegetables such as, for example, onions and carrots, broccoli, cauliflower, white cabbage, tomato, paprika, melon, courgette and cucumbers, or various pome fruit plants, such as, for example, apple or pear. Particularly important is the treatment of the seed of maize, soya, cotton, wheat and canola or oilseed rape. Preferred vegetables are onions and carrots.

As already mentioned above, the treatment of transgenic seed with a composition according to the invention is also particularly important. This may take the form of seed of plants which, as a rule, comprise at least one heterologous gene which controls the expression of a polypeptide with, in particular, insecticidal properties. The heterologous genes in transgenic seed can be derived from microorganisms such as Bacillus, Rhizobium, Pseudomonas, Serratia, Trichoderma, Clavibacter, Glomus or Gliocladium. The present invention is particularly suitable for the treatment of transgenic seed which comprises at least one heterologous gene from Bacillus sp. and whose gene product shows activity against the European corn borer and/or the corn rootworm. Especially preferably, this takes the form of a heterologous gene from Bacillus thuringiensis.

Within the scope of the present invention, the composition according to the invention is applied to the seed either alone or in the form of a suitable formulation. The seed is preferably treated in a state in which it is sufficiently stable to avoid damage during the treatment. In general, treatment of the seed can be effected at any point in time between harvest and sowing. Usually, seed is used which has been separated from the plant and freed from cobs, hulls, stems, coats, hair or pulp.

Thus, for example, it is possible to use seed which has been harvested, cleaned and dried down to a moisture content of less than 15% by weight. However, it is also possible to use seed which has been treated for example with water after drying and then redried.

When treating seed, care must be taken generally that the amount of the composition according to the invention and/or further additives which is/are applied to the seed is chosen in such a way that the germination of the seed is not adversely affected, or the plant which the seed gives rise to is not damaged. This is in particular the case for active substances which may have phytotoxic effects at certain application rates.

The compositions according to the invention can be applied directly, which means without comprising further components and without having been diluted. As a rule, it is preferable to apply the compositions to the seed in the form of a suitable formulation. Suitable formulations and methods for the treatment of seed are known to the skilled worker and are described, for example, in the following documents: U.S. Pat. No. 4,272,417 A, U.S. Pat. No. 4,245,432 A, U.S. Pat. No. 4,808,430 A, U.S. Pat. No. 5,876,739 A, US 2003/0176428 A1, WO 2002/080675 A1, WO 2002/028186 A2.

The active substance combinations are well tolerated by plants, have favourable toxicity to warm-blooded species and are suitable for controlling animal pests, in particular insects, arachnids and nematodes which occur in agriculture, in afforestations, in the protection of stored products and materials, and in the hygiene sector. They can preferably be employed as plant protection agents. They are active against normally sensitive and resistant species, and against all or individual developmental stages. The abovementioned pests include:

From the order of the Isopoda, for example, Oniscus asellus, Armadillidium vulgare, Porcellio scaber.

From the order of the Diplopoda, for example, Blaniulus guttulatus.

From the order of the Chilopoda, for example, Geophilus carpophagus, Scutigera spp.

From the order of the Symphyla, for example, Scutigerella immaculata.

From the order of the Thysanura, for example, Lepisma saccharina.

From the order of the Collembola, for example, Onychiurus armatus.

From the order of the Orthoptera, for example, Acheta domesticus, Gryllotalpa spp., Locusta migratoria migratorioides, Melanoplus spp., Schistocerca gregaria.

From the order of the Blattaria, for example, Blatta orientalis, Periplaneta americana, Leucophaea maderae, Blattella germanica.

From the order of the Dermaptera, for example, Forficula auricularia.

From the order of the Isoptera, for example, Reticulitermes spp.

From the order of the Phthiraptera, for example, Pediculus humanus corporis, Haematopinus spp., Linognathus spp., Trichodectes spp., Damalinia spp.

From the order of the Thysanoptera, for example, Hercinothrips femoralis, Thrips tabaci, Thrips palmi, Frankliniella occidentalis.

From the order of the Heteroptera, for example, Eurygaster spp., Dysdercus intermedius, Piesma quadrata, Cimex lectularius, Rhodnius prolixus, Triatoma spp.

From the order of the Homoptera, for example, Aleurodes brassicae, Bemisia tabaci, Trialeurodes vaporariorum, Aphis gossypii, Brevicoryne brassicae, Cryptomyzus ribis, Aphis fabae, Aphis pomi, Eriosoma lanigerum, Hyalopterus arundinis, Phylloxera vastatrix, Pemphigus spp., Macro-siphum avenae, Myzus spp., Phorodon humuli, Rhopalosiphum padi, Empoasca spp., Euscelis bilobatus, Nephotettix cincticeps, Lecanium comi, Saissetia oleae, Laodelphax striatellus, Nilaparvata lugens, Aonidiella aurantii, Aspidiotus hederae, Pseudococcus spp., Psylla spp.

From the order of the Lepidoptera, for example, Pectinophora gossypiella, Bupalus piniarius, Chematobia brumata, Lithocolletis blancardella, Hyponomeuta padella, Plutella xylostella, Malacosoma neustria, Euproctis chrysorrhoea, Lymantria spp., Bucculatrix thurberiella, Phyllocnistis citrella, Agrotis spp., Euxoa spp., Feltia spp., Earias insulana, Heliothis spp., Mamestra brassicae, Panolis flammea, Spodoptera spp., Trichoplusia ni, Carpocapsa pomonella, Pieris spp., Chilo spp., Pyrausta nubilalis, Ephestia kuehniella, Galleria mellonella, Tineola bisselliella, Tinea pellionella, Hofinannophila pseudospretella, Cacoecia podana, Capua reticulana, Choristoneura fumiferana, Clysia ambiguella, Homona magnanima, Tortrix viridana, Cnaphalocerus spp., Oulema oryzae.

From the order of the Coleoptera, for example, Anobium punctatum, Rhizopertha dominica, Bruchidius obtectus, Acanthoscelides obtectus, Hylotrupes bajulus, Agelastica alni, Leptinotarsa decemlineata, Phaedon cochleariae, Diabrotica spp., Psylliodes chrysocephala, Epilachna varivestis, Atomaria spp., Oryzaephilus surinamensis, Anthonomus spp., Sitophilus spp., Otiorrhynchus sulcatus, Cosmopolites sordidus, Ceuthorrhynchus assimilis, Hypera postica, Dermestes spp., Trogoderma spp., Anthrenus spp., Attagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha melolontha, Amphimallon solstitialis, Costelytra zealandica, Lissorhoptrus oryzophilus.

From the order of the Hymenoptera, for example, Diprion spp., Hoplocampa spp., Lasius spp., Monomorium pharaonis, Vespa spp.

From the order of the Diptera, for example, Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae, Tipula paludosa, Hylemyia spp., Liriomyza spp.

From the order of the Siphonaptera, for example, Xenopsylla cheopis, Ceratophyllus spp.

From the class of the Arachnida, for example, Scorpio maurus, Latrodectus mactans, Acarus siro, Argas spp., Ornithodoros spp., Dermanyssus gallinae, Eriophyes ribis, Phyllocoptruta oleivora, Boophilus spp., Rhipicephalus spp., Amblyomma spp., Hyalomma spp., Ixodes spp., Psoroptes spp., Chorioptes spp., Sarcoptes spp., Tarsonemus spp., Bryobia praetiosa, Panonychus spp., Tetranychus spp., Hemitarsonemus spp., Brevipalpus spp.

The plant-parasitic nematodes include, for example, Pratylenchus spp., Radopholus similis, Ditylenchus dipsaci, Tylenchulus semipenetrans, Heterodera spp., Globodera spp., Meloidogyne spp., Aphelenchoides spp., Longidorus spp., Xiphinema spp., Trichodorus spp., Bursaphelenchus spp.

All plants and plant parts can be treated in accordance with the invention. Plants are understood as meaning all plants and plant populations, such as desired and undesired wild plants or crop plants (including naturally occurring crop plants). Crop plants can be plants which can be obtained by traditional breeding and optimization methods or by biotechnological and recombinant methods, or combinations of these methods, including the transgenic plants and including the plant varieties capable or not of being protected by Plant Breeders' Rights. Plant parts are understood as meaning all aerial and subterranean parts and organs of the plants, such as shoot, leaf, flower and root, examples which may be mentioned being leaves, needles, stalks, stems, flowers, fruiting bodies, fruits and seeds, and also roots, tubers and rhizomes. The plant parts also include harvested material and vegetative and generative propagation material, for example cuttings, tubers, rhizomes, slips and seeds.

What may be emphasized in this context is the particularly advantageous effect of the compositions according to the invention with regard to their use in cereal plants such as, for example, wheat, oats, barley, spelt, triticale and rye, but also in maize, sorghum and millet, rice, sugar cane, soya, sunflowers, potatoes, cotton, oilseed rape, canola, tobacco, sugar beet, fodder beet, asparagus, hops and fruit plants (comprising pome fruit such as, for example, apples and pears, stem fruit such as, for example, peaches, nectarines, cherries, plums and apricots, citrus fruits such as, for example, oranges, grapefruits, limes, lemons, cumquats, tangerines and satsumas, nuts such as, for example, pistachios, almonds, walnuts and pecan nuts, tropical fruits such as, for example, mango, paw-paw, pineapple, dates and bananas, and grapes) and vegetables (comprising leafy vegetables such as, for example, endives, corn salad, Florence fennel, various types of head lettuce and cut-and-come-again lettuce, Swiss chard, spinach and chicory, cabbages such as, for example, cauliflower, broccoli, Chinese leaves, borecole (curly kale or feathered cabbage), kohlrabi, Brussels sprouts, red cabbage, white cabbage and savoy cabbage, fruit vegetables such as, for example, aubergines, cucumbers, capsicums, table pumpkins, tomatoes, courgettes and sweetcom, root vegetables such as, for example, celeriac, early turnips, carrots, including yellow cultivars, radish, small radish, beetroot, scorzonera and celery, legumes such as, for example, peas and beans, and bulb vegetables such as, for example, leeks and onions).

The active substance combinations can be converted into the customary formulations, such as solutions, emulsions, wettable powders, suspensions, powders, dusts, pastes, soluble powders, granules, suspoemulsion concentrates, natural and synthetic substances impregnated with active substance, and microencapsulations in polymeric substances.

These formulations are produced in a known manner, for example by mixing the active substances with extenders, that is liquid solvents and/or solid carriers, optionally with the use of surface-active agents, that is emulsifiers and/or dispersants and/or foam formers.

If water is used as extender, cosolvents which can also be used are, for example, organic solvents.

The following are mainly suitable as liquid solvents: aromatics such as xylene, toluene or alkyl-naphthalenes, chlorinated aromatics and chlorinated aliphatic hydrocarbons such as chlorobenzenes, chloroethylenes or methylene chloride, aliphatic hydrocarbons such as cyclohexane or paraffins, for example mineral oil fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, and water.

The following are suitable as solid carriers:

for example ammonium salts and ground natural minerals, such as kaolins, clays, talc, chalk, quartz, attapulgite, montmorillonite or diatomaceous earth, and ground synthetic minerals such as highly dispersed silica, alumina and silicates; the following are suitable as solid carriers for granules: for example crushed and fractionated natural rocks such as calcite, marble, pumice, sepiolite and dolomite, and synthetic granules of inorganic and organic minerals, and granules of organic material such as sawdust, coconut shells, maize cobs and tobacco stalks; the following are suitable as emulsifiers and/or foam formers: for example nonionic and anionic emulsifiers such as polyoxyethylene fatty acid esters, polyoxyethylene fatty alcohol ethers, for example alkylaryl polyglycol ethers, alkylsulphonates, alkyl sulphates, arylsulphonates and protein hydrolysates; the following are suitable as dispersants: for example lignosulphite waste liquors and methylcellulose.

Adhesives such as carboxymethylcellulose and natural and synthetic polymers in the form of powders, granules or latices, such as gum arabic, polyvinyl alcohol and polyvinyl acetate, and natural phospholipids, such as cephalins and lecithins, and synthetic phospholipids can be used in the formulations. Further additives may be mineral and vegetable oils.

It is possible to use colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc.

In general, the formulations comprise between 0.1 and 95% by weight of active substance, preferably between 0.5 and 90%.

The active substance combinations according to the invention preferably comprise no further active substances, besides the two chloronicotinyl insecticides of the formulae (I) to (VII).

If appropriate, the active substance combinations according to the invention, in commercially available formulations and in the use forms prepared from these formulations, can be present in a mixture with other active substances, such as insecticides, attractants, sterilants, bactericides, acaricides, nematicides, fungicides, growth regulators or herbicides. The insecticides include, for example, phosphoric esters, carbamates, carboxylic esters, chlorinated hydrocarbons, phenylureas, substances produced by microorganisms and the like.

Particularly advantageous mixing partners are, for example, the following:

### Fungicides:

aldimorph, ampropylfos, ampropylfos-potassium, andoprim, anilazine, azaconazole, azoxystrobin, benalaxyl, benodanil, benomyl, benzamacril, benzamacryl-isobutyl, bialaphos, binapacryl, biphenyl, bitertanol, blasticidin-S, bromuconazole, bupirimate, buthiobate,
calcium polysulphide, capsimycin, captafol, captan, carbendazim, carboxin, carvon, quinomethionate, chlobenthiazone, chlorfenazole, chloroneb, chloropicrin, chlorothalonil, chlozolinate, clozylacon, cufraneb, cymoxanil, cyproconazole, cyprodinil, cyprofuram,
debacarb, dichlorophen, diclobutrazol, diclofluanid, diclomezine, dicloran, diethofencarb, difenoconazole, dimethirimol, dimethomorph, diniconazole, diniconazole-M, dinocap, diphenylamine, dipyrithione, ditalimfos, dithianon, dodemorph, dodine, drazoxolon,
ediphenphos, epoxiconazole, etaconazole, ethirimol, etridiazole,
famoxadon, fenapanil, fenarimol, fenbuconazole, fenfuram, fenitropan, fenpiclonil, fenpropidin, fenpropimorph, fentin acetate, fentin hydroxide, ferbam, ferimzone, fluazinam, flumetover, fluoromide, fluquinconazole, flurprimidol, flusilazole, flusulfamide, flutolanil, flutriafol, folpet, fosetyl-aluminium, fosetyl-sodium, fthalide, fuberidazole, furalaxyl, furametpyr, furcarbonil, furconazole, furconazole-cis, firmecyclox,
guazatine,
hexachlorobenzene, hexaconazole, hymexazol,
imazalil, imibenconazole, iminoctadine, iminoctadine albesilate, irminoctadine triacetate, iodocarb, ipconazole, iprobenfos (IBP), iprodione, irumamycin, isoprothiolane, isovaledione,
kasugamycin, kresoxim-methyl, copper preparations such as copper hydroxide, copper naphthenate, copper oxychloride, copper sulphate, copper oxide, oxine-copper and Bordeaux mixture,
mancopper, mancozeb, maneb, meferimzone, mepanipyrim, mepronil, metalaxyl, metconazole, methasulfocarb, methfuroxam, metiram, metomeclam, metsulfovax, mildiomycin, myclobutanil, myclozolin,
nickel dimethyldithiocarbamate, nitrothal-isopropyl, nuarimol,
ofurace, oxadixyl, oxamocarb, oxolinic acid, oxycarboxim, oxyfenthiin,
paclobutrazol, pefurazoate, penconazole, pencycuron, phosdiphen, pimaricin, piperalin, polyoxin, polyoxorim, probenazole, prochloraz, procymidone, propamocarb, propanosine-sodium, propiconazole, propineb, pyrazophos, pyrifenox, pyrimethanil, pyroquilon, pyroxyfur, quinconazole, quintozene (PCNB),
sulphur and sulphur preparations,
tebuconazole, tecloftalam, tecnazene, tetcyclacis, tetraconazole, thiabendazole, thicyofen, thifluzamide, thiophanate-methyl, thiram, tioxymid, tolclofos-methyl, tolylfluanid, triadimefon, triadimenol, triazbutil, triazoxide, trichlamide, tricyclazole, tridemorph, triflumizole, triforine, triticonazole,
uniconazole,
validamycin A, vinclozolin, viniconazole,
zarilamid, zineb, ziram, and also

### Dagger G,

### OK-8705,

### OK-8801,

α-(1,1-dimethylethyl)-β-(2-phenoxyethyl)-1H-1,2,4-triazole-1-ethanol,
α-(2,4-dichlorophenyl)-β-fluoro-β-propyl-1H-1,2,4-triazole-1-ethanol,
α-(2,4-dichlorophenyl)-β-methoxy-α-methyl-1H-1,2,4-triazole-1-ethanol,
α-(5-methyl-1,3-dioxan-5-yl)-β-[[4-(trifluoromethyl)phenyl]methylene]-1H-1,2,4-triazole-1-ethanol,
(5RS,6RS)-6-hydroxy-2,2,7,7-tetramethyl-5-(1H-1,2,4-triazol-1-yl)-3-octanone,
(E)-α-(methoxyimino)-N-methyl-2-phenoxyphenylacetamide,
1-isopropyl {2-methyl-1-[[[1-(4-methylphenyl)ethyl]amino]carbonyl]propyl}carbamate
1-(2,4-dichlorophenyl)-2-(1H-1,2,4-triazol-1-yl)ethanone O-(phenylmethyl)oxime,
1-(2-methyl-1-naphthalenyl)-1H-pyrrole-2,5-dione,
1-(3,5-dichlorophenyl)-3-(2-propenyl)-2,5-pyrrolidinedione,
1-[(diiodomethyl)sulphonyl]-4-methylbenzene,
1-[[2-(2,4-dichlorophenyl)-1,3-dioxolan-2-yl]methyl]-1H-imidazole,
1-[[2-(4-chlorophenyl)-3-phenyloxiranyl]methyl]-1H-1,2,4-triazole,
1-[1-[2-[(2,4-dichlorophenyl)methoxy]phenyl]ethenyl]-1H-imidazole,
1-methyl-5-nonyl-2-(phenylmethyl)-3-pyrrolidinol,
2′,6′-dibromo-2-methyl-4′-trifluoromethoxy-4′-trifluoromethyl-1,3-thiazole-5-carboxanilide,
2,2-dichloro-N-[1-(4-chlorophenyl)ethyl]-1-ethyl-3-methylcyclopropanecarboxamide,
2,6-dichloro-5-(methylthio)-4-pyrimidinyl thiocyanate,
2,6-dichloro-N-(4-trifluoromethylbenzyl)benzamide,
2,6-dichloro-N-[[4-(trifluoromethyl)phenyl]methyl]benzamide,
2-(2,3,3-triiodo-2-propenyl)-2H-tetrazole,
2-[(1-methylethyl)sulphonyl]-5-(trichloromethyl)-1,3,4-thiadiazole,
2-[[6-deoxy-4-O-(4-O-methyl-β-D-glycopyranosyl)-α-D-glucopyranosyl]amino]-4-methoxy-1H-pyrrolo[2,3-d]pyrimidine-5-carbonitrile,
2-aminobutane,
2-bromo-2-(bromomethyl)pentanonitrile,
2-chloro-N-(2,3-dihydro-1,1,3-trimethyl-1H-inden-4-yl)-3-pyridinecarboxamide,
2-chloro-N-(2,6-dimethylphenyl)-N-(isothiocyanatomethyl)acetamide,
2-phenylphenol(OPP),
3,4-dichloro-1-[4-(difluoromethoxy)phenyl]-1H-pyrrole-2,5-dione,
3,5-dichloro-N-[cyano[(1-methyl-2-propynyl)oxy]methyl]benzamide,
3-(1,1-dimethylpropyl-1-oxo)-1H-indene-2-carbonitrile,
3-[2-(4-chlorophenyl)-5-ethoxy-3-isoxazolidinyl]pyridine,
4-chloro-2-cyano-N,N-dimethyl-5-(4-methylphenyl)-1H-imidazole-1-sulphonamide,
4-methyltetrazolo[1,5-a]quinazolin-5(4H)-one,
8-(1,1-dimethylethyl)-N-ethyl-N-propyl-1,4-dioxaspiro[4.5]decane-2-methanamine,
8-hydroxyquinoline sulphate,
9H-xanthene-9-carboxylic acid 2-[(phenylamino)carbonyl]hydrazide,
bis(1-methylethyl)-3-methyl-4-[(3-methylbenzoyl)oxy]-2,5-thiophene dicarboxylate,
cis-1-(4-chlorophenyl)-2-(1H-1,2,4-triazol-1-yl)cycloheptanol,
cis-4-[3-[4-(1,1-dimethylpropyl)phenyl-2-methylpropyl]-2,6-dimethylmorpholine hydrochloride,
ethyl [(4-chlorophenyl)azo]cyanoacetate,
potassium hydrogen carbonate,
sodium methanetetrathiolate,
methyl-1-(2,3-dihydro-2,2-dimethyl-1H-inden-1-yl)-1H-imidazole-5-carboxylate,
methyl N-(2,6-dimethylphenyl)-N-(5-isoxazolylcarbonyl)-DL-alaninate,
methyl N-(chloroacetyl)-N-(2,6-dimethylphenyl)-DL-alaninate,
N-(2,3-dichloro-4-hydroxyphenyl)-1-methylcyclohexanecarboxamide,
N-(2,6-dimethylphenyl)-2-methoxy-N-(tetrahydro-2-oxo-3-furanyl)acetamide,
N-(2,6-dimethylphenyl)-2-methoxy-N-(tetrahydro-2-oxo-3-thienyl)acetamide,
N-(2-chloro-4-nitrophenyl)-4-methyl-3-nitrobenzenesulphonamide,
N-(4-cyclohexylphenyl)-1,4,5,6-tetrahydro-2-pyrimidinamine,
N-(4-hexylphenyl)-1,4,5,6-tetrahydro-2-pyrimidinamine,
N-(5-chloro-2-methylphenyl)-2-methoxy-N-(2-oxo-3-oxazolidinyl)acetamide,
N-(6-methoxy)-3-pyridinyl)cyclopropanecarboxamide,
N-[2,2,2-trichloro-1-[(chloroacetyl)amino]ethyl]benzamide,
N-[3-chloro-4,5-bis(2-propinyloxy)phenyl]-N′-methoxymethanimidamide,
sodium N-formyl-N-hydroxy-DL-alaninate,
O,O-diethyl [2-(dipropylamino)-2-oxoethyl]ethylphosphoramidothioate,
O-methyl S-phenyl phenylpropylphosphoramidothioate,
S-methyl 1,2,3-benzothiadiazole-7-carbothioate,
spiro[2H]-1-benzopyran-2,1′(3′H)-isobenzofuran]-3′-one.

### Bactericides:

bronopol, dichlorophen, nitrapyrin, nickel dimethyldithiocarbamate, kasugamycin, octhilinone, furancarboxylic acid, oxytetracyclin, probenazole, streptomycin, tecloftalam, copper sulphate and other copper preparations.

### Insecticides/Acaricides/Nematicides

1. Acetylcholin esterase (AChE) inhibitors
1.1 carbamates, for example
   alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb,
   triazamate
1.2 organophosphates, for example
   acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chloropyrifos(-methyl/-ethyl), coumaphos, cyanofenphos, cyanophos, chlorfenvinphos, demeton-5-methyl, demeton-5-methyl sulfone, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion
2. Sodium channel modulators/voltage-dependent sodium channel blockers
2.1 pyrethroids, for example
   acrinathrin, allethrin (d-cis-trans, d-trans), beta-cyfluthrin, bifenthrin, bioallethrin, bioallethrin-S-cyclopentyl isomer, bioethanomethrin, biopermethrin, biores-methrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R trans isomer), prallethrin, profluthrin, protrifenbute, pyresmethrin, resmethrin, RU 15525, silafluofen, tau-fluvalinate, tefluthrin, terallethrin, tetramethrin (1R isomer), tralomethrin, transfluthrin, ZXI 8901, pyrethrins (pyrethrum)
   DDT
2.2 oxadiazines, for example indoxacarb
3. Acetylcholin receptor agonists/antagonists
3.1 Chloronicotinyls, for example
   acetamiprid, clothianidin, dinotefuran, imidacloprid, nitenpyram, nithiazine, thiacloprid, thiamethoxam
3.2 nicotine, bensultap, cartap
4. Acetylcholin receptor modulators
4.1 spinosyns, for example spinosad
5. GABA-controlled chloride channel antagonists
5.1 cyclodiene organochlorins, for example
   camphechlor, chlordane, endosulfan, gamma-HCH, HCH, heptachlor, lindane, methoxychlor
5.2 fiprols, for example
   acetoprole, ethiprole, fipronil, vaniliprole
6. Chloride channel activators
6.1 mectins, for example
   avermectin, emamectin, emamectin-benzoate, ivermectin, milbemycin
7. Juvenile hormone mimetics, for example
   diofenolan, epofenonane, fenoxycarb, hydroprene, kinoprene, methoprene, pyri-proxifen, triprene
8. Ecdysone agonists/disruptors
8.1 diacylhydrazines, for example
   chromafenozide, halofenozide, methoxyfenozide, tebufenozide
9. Chitin biosynthesis inhibitors
9.1 benzoylureas, for example
   bistrifluoron, chlofluazuron, diflubenzuron, fluazuron, flucycloxuron, flufenoxuron, hexaflumuron, lufenuron, novaluron, noviflumuron, penfluoron, teflubenzuron, triflumuron
9.2 buprofezin
9.3 cyromazine
10. Inhibitors of oxidative phosphorylation, ATP disruptors
10.1 diafenthiuron
10.2 organotin compounds, for example azocyclotin, cyhexatin, fenbutatin-oxide
11. Uncouplers of oxidative phosphorylation by interrupting the H proton gradient
11.1 pyrroles, for example chlorfenapyr
11.2 dinitrophenols, for example binapacyrl, dinobuton, dinocap, DNOC
12. Site-I electron transport inhibitors
12.1 METIs, for example fenazaquin, fenpyroximate, pyrimidifen, pyridaben, tebufenpyrad, tolfenpyrad
12.2 hydramethylnon
12.3 dicofol
13. Site-II electron transport inhibitors
   rotenone
14. Site-III electron transport inhibitors
   acequinocyl, fluacrypyrim
15. Microbial disruptors of the insect gut membrane
   Bacillus thuringiensis strains
16. Fat biosynthesis inhibitors
   tetronic acids, for example
      spirodiclofen, spiromesifen
   tetramic acids, for example
      3-(2,5-dimethylphenyl)-8-methoxy-2-oxo-1-azaspiro[4.5]dec-3-en-4-yl ethyl carbonate (also known as:
      carbonic acid, 3-(2,5-dimethylphenyl)-8-methoxy-2-oxo-1-azaspiro[4.5]dec-3-en-4-yl ethyl ester, CAS-Reg.-No.: 382608-10-8) and carbonic acid, cis-3-(2,5-dimethylphenyl)-8-methoxy-2-oxo-1-azaspiro[4.5]dec-3-en-4-yl ethyl ester (CAS-Reg.-No.: 203313-25-1)
17. Carboxamides, for example flonicamid
18. Octopaminergic agonists, for example amitraz
19. Inhibitors of magnesium-stimulated ATPase, for example propargite
20. BDCAs, for example N2-[1,1-dimethyl-2-(methylsulphonyl)ethyl]-3-iodo-N1-[2-methyl-4-[1,2,2,2-tetrafluoro-1-(trifluoromethyl)ethyl]phenyl]-1,2-benzenedicarboxamide (CAS-Reg. No.: 272451-65-7)
21. Nereistoxin analogues, for example thiocyclam hydrogen oxalate, thiosultap-sodium
22. Biologicals, hormones or pheromones, for example
   azadirachtin, Bacillus spec., Beauveria spec., codlemone, Metarrhizium spec., Paecilomyces spec., Thuringiensin, Verticillium spec.
23. Active substances with unknown or unspecific mechanisms of action
23.1 Fumigants, for example
   aluminium phosphide, methyl bromide, sulphuryl fluoride
23.2 Selective antifeedants, for example
   cryolite, flonicamid, pymetrozine
23.3 mite growth inhibitors, for example
   clofentezine, etoxazole, hexythiazox
23.4 amidoflumet, benclothiaz, benzoximate, bifenazate, bromopropylate, buprofezin, quino-methionate, chlordimeform, chlorobenzilate, chloropicrin, clothiazoben, cycloprene, dicyclanil, fenoxacrim, fentrifanil, flubenzimine, flufenerim, flutenzin, Gossyplure, hydramethylnone, Japonilure, metoxadiazone, petroleum, piperonyl butoxide, potassium oleate, pyridalyl, sulfluramid, tetradifon, tetrasul, triarathene, verbutin,
   furthermore
(1R-cis)-[5-(phenylmethyl)-3-furanyl]methyl-3-[(dihydro-2-oxo-3(2H-furanylidene)methyl]2,2-dimethylcyclopropanecarboxylate
(3-phenoxyphenyl)methyl-2,2,3,3-tetramethylcyclopropanecarboxylate
1-[(2-chloro-5-thiazolyl)methyl]tetrahydro-3,5-dimethyl-N-nitro-1,3,5-triazine-2(1H)-imine
2-(2-chloro-6-fluorophenyl)-4-[4-(1,1-dimethylethyl)phenyl]-4,5-dihydrooxazole
2-(acetyloxy)-3-dodecyl-1,4-naphthalenedione
2-chloro-N-[[[4-(1-phenylethoxy)phenyl]amino]carbonyl]benzamide
2-chloro-N-[[[4-(2,2-dichloro-1,1-difluoroethoxy)phenyl]amino]carbonyl]benzamide
3-methylphenyl propylcarbamate
4-[4-(4-ethoxyphenyl)-4-methylpentyl]-1-fluoro-2-phenoxybenzene
4-chloro-2-(1,1-dimethylethyl)-5-[[2-(2,6-dimethyl-4-phenoxyphenoxy)ethyl]thio]-3(2H)-pyridazinone
4-chloro-2-(2-chloro-2-methylpropyl)-5-[(6-iodo-3-pyridinyl)methoxy]-3(2H)-pyridazinone
4-chloro-5-[(6-chloro-3-pyridinyl)methoxy]-2-(3,4-dichlorophenyl)-3(2H)-pyridazinone
Bacillus thuringiensis strain EG-2348
benzoic acid [2-benzoyl-1-(1,1-dimethylethyl)hydrazide
2,2-dimethyl-3-(2,4-dichlorophenyl)-2-oxo-1-oxaspiro[4.5]dec-3-en-4-yl butanoate
[3-[(6-chloro-3-pyridinyl)methyl]-2-thiazolidinylidene]cyanamide
dihydro-2-(nitromethylene)-2H-1,3-thiazine-3(4H)-carboxaldehyde
ethyl [2-[[1,6-dihydro-6-oxo-1-(phenylmethyl)-4-pyridazinyl]oxy]ethyl]carbamate
N-(3,4,4-trifluoro-1-oxo-3-butenyl)glycine
N-(4-chlorophenyl)-3-[4-(difluoromethoxy)phenyl]-4,5-dihydro-4-phenyl-1H-pyrazole-1-carboxamide
N-methyl-N′-(1-methyl-2-propenyl)-1,2-hydrazinedicarbothioamide
N-methyl-N′-2-propenyl-1,2-hydrazinedicarbothioamide
O,O-diethyl [2-(dipropylamino)-2-oxoethyl]ethylphosphoramidothioate

A mixture of other known active substances such as herbicides, or with fertilizers and growth regulators, is also possible.

Furthermore, when employed as insecticides, the active substance combinations according to the invention in their commercially available formulations and in the use forms prepared from these formulations may be present as a mixture with synergists. Synergists are compounds by which the activity of the active substances is increased without it being necessary for the added synergist to be active itself.

The active substance content of the use forms prepared from the commercially available formulations can vary within wide limits. The active substance concentration of the use forms can be from 0.0000001 to 95% by weight of active substance, preferably between 0.0001 and 1% by weight.

They are applied in a customary manner adapted to suit the use forms.

When employed against hygiene pests and stored-product pests, the active substance combinations are distinguished by an outstanding residual action on wood and clay and by a good stability to alkali on limed surfaces.

The active substance combinations according to the invention are not only active against plant pests, hygiene pests and stored-product pests, but also, in the sector of veterinary medicine, against animal parasites (ectoparasites) such as hard ticks, soft ticks, scab mites, harvest mites, flies (stinging and licking), parasitic fly larvae, lice, hair lice, bird lice and flees. These parasites include:

From the order of the Anoplurida, for example Haematopinus spp., Linognathus spp., Pediculus spp., Phtirus spp., Solenopotes spp.

From the order of the Mallophagida and the suborders Amblycerina and Ischnocerina, for example Trimenopon spp., Menopon spp., Trinoton spp., Bovicola spp., Wemeckiella spp., Lepikentron spp., Damalina spp., Trichodectes spp., Felicola spp.

From the order of the Diptera and the suborders Nematocerina and Brachycerina, for example Aedes spp., Anopheles spp., Culex spp., Simulium spp., Eusimulium spp., Phlebotomus spp., Lutzomyia spp., Culicoides spp., Chrysops spp., Hybomitra spp., Atylotus spp., Tabanus spp., Haematopota spp., Philipomyia spp., Braula spp., Musca spp., Hydrotaea spp., Stomoxys spp., Haematobia spp., Morellia spp., Fannia spp., Glossina spp., Calliphora spp., Lucilia spp., Chrysomyia spp., Wohlfahrtia spp., Sarcophaga spp., Oestrus spp., Hypoderma spp., Gasterophilus spp., Hippobosca spp., Lipoptena spp., Melophagus spp.

From the order of the Siphonapterida, for example Pulex spp., Ctenocephalides spp., Xenopsylla spp., Ceratophyllus spp.

From the order of the Heteropterida, for example Cimex spp., Triatoma spp., Rhodnius spp., Panstrongylus spp.

From the order of the Blattarida, for example Blatta orientalis, Periplaneta americana, Blattela germanica, Supella spp.

From the subclass of the Acari (Acarina) and the orders of the Meta- and Mesostigmata, for example Argas spp., Ornithodorus spp., Otobius spp., Ixodes spp., Amblyomma spp., Boophilus spp., Dermacentor spp., Haemophysalis spp., Hyalomma spp., Rhipicephalus spp., Dermanyssus spp., Raillietia spp., Pneumonyssus spp., Stemostoma spp., Varroa spp.

From the order of the Actinedida (Prostigmata) and Acaridida (Astigmata), for example Acarapis spp., Cheyletiella spp., Ornithocheyletia spp., Myobia spp., Psorergates spp., Demodex spp., Trombicula spp., Listrophorus spp., Acarus spp., Tyrophagus spp., Caloglyphus spp., Hypodectes spp., Pterolichus spp., Psoroptes spp., Chorioptes spp., Otodectes spp., Sarcoptes spp., Notoedres spp., Knemidocoptes spp., Cytodites spp., Laminosioptes spp.

The active substance combinations according to the invention are also suitable for controlling arthropods which infest agricultural livestock such as, for example, cattle, sheep, goats, horses, pigs, donkeys, camels, buffaloes, rabbits, chickens, turkeys, ducks, geese, honeybees, other domestic animals such as, for example, dogs, cats, cage birds, aquarium fish and what are known as experimental animals such as, for example, hamsters, guinea pigs, rats and mice. By controlling these arthropods, it is intended to reduce deaths and reduce performance (in the case of meat, milk, wool, hides, eggs, honey and the like), so that more economical and simpler animal keeping is made possible by the use of the active substance combinations according to the invention.

In the veterinary sector, the active substance combinations according to the invention are applied in a known manner by enteral administration in the form of, for example, tablets, capsules, drinks, drenches, granules, pastes, boluses, the feed-through method, suppositories, by parenteral administration, such as, for example, by injections (intramuscular, subcutaneous, intravenous, intraperitoneal and the like), implants, by nasal application, by dermal application in the form of, for example, bathing or dipping, spraying, pouring-on and spotting-on, washing, dusting, and with the aid of active-substance-comprising shaped articles such as collars, ear tags, tail tags, limb bands, halters, marking devices and the like.

When used for livestock, poultry, domestic animals and the like, the active substances can be applied as formulations (for example powders, emulsions, flowables) which comprise the active substances in an amount of from 1 to 80% by weight, either directly or after 100- to 10 000-fold dilution, or else as a chemical bath.

Furthermore, it has been found that the active substance combinations according to the invention have a potent insecticidal activity against insects which destroy industrial materials.

The following insects may be mentioned by way of example and by preference, but not by limitation:

Beetles such as

Hylotrupes bajulus, Chlorophorus pilosis, Anobium punctatum, Xestobium rufovillosum, Ptilinus pecticomis, Dendrobium pertinex, Emobius mollis, Priobium carpini, Lyctus brunneus, Lyctus africanus, Lyctus planicollis, Lyctus linearis, Lyctus pubescens, Trogoxylon aequale, Minthes rugicollis, Xyleborus spec., Tryptodendron spec., Apate monachus, Bostrychus capucins, Heterobostrychus brunneus, Sinoxylon spec. Dinoderus minutus.

Hymenopterasuch as

Sirex juvencus, Urocerus gigas, Urocerus gigas taignus, Urocerus augur.

Termites such as

Kalotermes flavicollis, Cryptotermes brevis, Heterotermes indicola, Reticulitermes flavipes, Reticulitermes santonensis, Reticulitermes lucifugus, Mastotermes darwiniensis, Zootermopsis nevadensis, Coptotermes formosanus.

Bristletails such as Lepisma saccharina.

Industrial materials are understood as meaning, in the present context, non-live materials such as, preferably, polymers, adhesives, glues, paper and board, leather, timber, derived timber products and paints.

The material to be protected from infestation with insects is very especially preferably timber and derived timber products.

Timber and derived timber products which can be protected by the composition according to the invention, or by mixtures comprising it, are to be understood as meaning, for example:

structural timber, wooden beams, railway sleepers, components of bridges, jetties, vehicles made of wood, boxes, pallets, containers, telegraph poles, wooden lagging, windows and doors made of wood, plywood, chipboard, joinery, or wooden products which are used, quite generally, for building houses or in building joinery.

The active substance combinations can be used as such, in the form of concentrates or generally customary formulations such as powder, granules, solutions, suspensions, emulsions or pastes.

The abovementioned formulations can be prepared in a manner known per se, for example by mixing the active substances with at least one solvent, diluent, emulsifier, dispersant and/or binder or fixative, water repellent, optionally siccatives and UV stabilizers, and optionally colourants and pigments as well as other processing auxiliaries.

The insecticidal compositions or concentrates which are used for the protection of timber and derived timber products comprise the active substance according to the invention in a concentration of from 0.0001 to 95% by weight, in particular 0.001 to 60% by weight.

The amount of compositions or concentrates employed depends on the species and the abundance of the insects and on the medium. Upon use, the optimal application rate can be determined in each case by a test series. However, in general it will suffice to employ 0.0001 to 20% by weight, preferably 0.001 to 10% by weight, of the active substance, based on the material to be protected.

A substance which acts as solvent and/or diluent is an organochemical solvent or solvent mixture and/or an oily or oil-type organochemical solvent or solvent mixture of low volatility and/or a polar organochemical solvent or solvent mixture and/or water and, if appropriate, an emulsifier and/or wetter.

Organochemical solvents which are preferably employed are oily or oil-type solvents with an evaporation number of greater than 35 and a flash point of above 30° C., preferably above 45° C. Such water-insoluble oily and oil-type solvents of low volatility which are employed are suitable mineral oils or their aromatic fractions or mineral-oil-containing solvent mixtures, preferably white spirit, petroleum and/or alkylbenzene.

Mineral oils which are advantageously used are those with a boiling range of from 170 to 220° C., white spirit with a boiling range of from 170 to 220° C., spindle oil with a boiling range of from 250 to 350° C., petroleum and aromatics with a boiling range of from 160 to 280° C., oil of turpentine, and the like.

In a preferred embodiment, liquid aliphatic hydrocarbons with a boiling range of from 180 to 210° C. or high-boiling mixtures of aromatic and aliphatic hydrocarbons with a boiling range of from 180 to 220° C. and/or spindle oil and/or monochloronaphthalene, preferably α-monochloronaphthalene are used.

The organic oily or oil-type solvents of low volatility and with an evaporation number of above 35 and a flash point of above 30° C., preferably above 45° C., can be replaced in part by organochemical solvents of high or medium volatility, with the proviso that the solvent mixture also has an evaporation number of above 35 and a flash point of above 30° C., preferably above 45° C., and that the insecticide/fungicide mixture is soluble or emulsifiable in this solvent mixture.

In a preferred embodiment, some of the organochemical solvent or solvent mixture is replaced by an aliphatic polar organochemical solvent or solvent mixture. Aliphatic organochemical solvents which contain hydroxyl and/or ester and/or ether groups are preferably used, such as, for example, glycol ethers, esters or the like.

Organochemical binders used for the purposes of the present invention are the synthetic resins or binding drying oils which are known per se and which can be diluted in water and/or dissolved or dispersed or emulsified in the organochemical solvents employed, in particular binders composed of, or comprising, an acrylate resin, a vinyl resin, for example polyvinyl acetate, polyester resin, polycondensation or polyaddition resin, polyurethane resin, alkyd resin or modified alkyd resin, phenol resin, hydrocarbon resin such as indene/coumarone resin, silicone resin, drying vegetable and/or drying oils and/or physically drying binders based on a natural and/or synthetic resin.

The synthetic resin employed as binder can be employed in the form of an emulsion, dispersion or solution. Bitumen or bituminous substances may also be used as binders, in amounts of up to 10% by weight. In addition, colourants, pigments, water repellents, odour-masking agents, and inhibitors or anticorrosive agents and the like, all of which are known per se, can be employed.

In accordance with the invention, the composition or the concentrate preferably comprises, as organochemical binders, at least one alkyd resin or modified alkyd resin and/or a drying vegetable oil. Alkyd resins which are preferably used in accordance with the invention are those with an oil content of over 45% by weight, preferably 50 to 68% by weight.

Some or all of the abovementioned binder can be replaced by a fixative (mixture) or plasticizer (mixture). These additives are intended to prevent volatilization of the active substances, and also crystallization or precipitation. They preferably replace 0.01 to 30% of the binder (based on 100% of binder employed).

The plasticizers are from the chemical classes of the phthalic esters such as dibutyl phthalate, dioctyl phthalate or benzyl butyl phthalate, phosphoric esters such as tributyl phosphate, adipic esters such as di(2-ethylhexyl)-adipate, stearates such as butyl stearate or amyl stearate, oleates such as butyl oleate, glycerol ethers or higher-molecular-weight glycol ethers, glycerol esters and p-toluenesulphonic esters.

Fixatives are based chemically on polyvinyl alkyl ethers such as, for example, polyvinyl methyl ether, or ketones such as benzophenone and ethylenebenzophenone.

Other suitable solvents or diluents are, in particular, also water, if appropriate as a mixture with one or more of the abovementioned organochemical solvents or diluents, emulsifiers and dispersants.

Particularly effective timber protection is achieved by industrial-scale impregnating processes, for example vacuum, double-vacuum or pressure processes.

If appropriate, the ready-to-use compositions can additionally contain further insecticides and, if appropriate, additionally one or more fungicides.

The active substance combinations according to the invention can also be employed for protecting objects which come into contact with saltwater or brackish water, such as hulls, screens, nets, buildings, moorings and signalling systems, from fouling.

Fouling by sessile Oligochaeta, such as Serpulidae, and by shells and species from the Ledamorpha group (goose barnacles), such as various Lepas and Scalpellum species, or by species from the Balanomorpha group (acorn barnacles), such as Balanus or Pollicipes species, increases the frictional drag of ships and, as a consequence, leads to a marked increase in operation costs owing to higher energy consumption and additionally frequent residence in the dry dock.

Apart from fouling by algae, for example Ectocarpus sp. and Ceramium sp., fouling by sessile Entomostraka groups, which come under the generic term Cirripedia (cirriped crustaceans), is of particular importance.

Surprisingly, it has now been found that the active substance combinations according to the invention have an outstanding antifouling action.

Using the active substance combinations according to the invention, the use of heavy metals such as, for example, in bis(trialkyltin) sulphides, tri-n-butyltin laurate, tri-n-butyltin chloride, copper(I) oxide, triethyltin chloride, tri-n-butyl(2-phenyl-4-chlorophenoxy)tin, tributyltin oxide, molybdenum disulphide, antimony oxide, polymeric butyl titanate, phenyl(bispyridine) bismuth chloride, tri-n-butyltin fluoride, manganese ethylenebisthiocarbamate, zinc dimethyldithio-carbamate, zinc ethylenebisthiocarbamate, zinc salts and copper salts of 2-pyridinethiol 1-oxide, bisdimethyldithiocarbamoylzinc ethylenebisthiocarbamate, zinc oxide, copper(I) ethylenebis-dithiocarbamate, copper thiocyanate, copper naphthenate and tributyltin halides can be dispensed with, or the concentration of these compounds substantially reduced.

If appropriate, the ready-to-use antifouling paints can additionally comprise other active substances, preferably algicides, fungicides, herbicides, molluscicides, or other antifouling active substances.

Preferably suitable combination partners for the antifouling compositions according to the invention are:

algicides such as
2-tert-butylamino-4-cyclopropylamino-6-methylthio-1,3,5-triazine, dichlorophen, diuron, endothal, fentine acetate, isoproturon, methabenzthiazuron, oxyfluorfen, quinoclamine and terbutryn;
fungicides such as
benzo[b]thiophenecarboxylic acid cyclohexylamide S,S-dioxide, dichlofluanid, fluorfolpet, 3-iodo-2-propynyl butylcarbamate, tolylfluanid and azoles such as
azaconazole, cyproconazole, epoxyconazole, hexaconazole, metconazole, propiconazole and tebuconazole;
molluscicides such as
Fe-complexing agents, fentin acetate, metaldehyde, methiocarb, niclosamide, thiodicarb and trimethacarb;
or conventional antifouling active substances such as
4,5-dichloro-2-octyl-4-isothiazolin-3-one, diiodomethylparatryl sulphone, 2-(N,N-dimethylthio-carbamoylthio)-5-nitrothiazyl, potassium, copper, sodium and zinc salts of 2-pyridinethiol 1-oxide, pyridinetriphenylborane, tetrabutyldistannoxane, 2,3,5,6-tetrachloro-4-(methylsulphonyl)pyridine, 2,4,5,6-tetrachloroisophthalonitrile, tetramethylthiuram disulphide and 2,4,6-trichlorophenyl-maleimide.

The antifouling compositions used comprise the active substance in a concentration of 0.001 to 50% by weight, in particular 0.01 to 20% by weight.

Moreover, the antifouling compositions comprise the customary components such as, for example, those described in Ungerer, Chem. Ind. 1985, 37, 730-732 and Williams, Antifouling Marine Coatings, Noyes, Park Ridge, 1973.

Besides the algicidal, fungicidal, molluscicidal and insecticidal active substances, antifouling paints comprise, in particular, binders.

Examples of recognized binders are polyvinyl chloride in a solvent system, chlorinated rubber in a solvent system, acrylic resins in a solvent system, in particular in an aqueous system, vinyl chloride/vinyl acetate copolymer systems in the form of aqueous dispersions or in the form of organic solvent systems, butadiene/styrene/acrylonitrile rubbers, drying oils such as linseed oil, resin esters or modified hardened resins in combination with tar or bitumens, asphalt and epoxy compounds, small amounts of chlorine rubber, chlorinated polypropylene and vinyl resins.

If appropriate, paints also comprise inorganic pigments, organic pigments or colourants which are preferably insoluble in saltwater. Paints may furthermore comprise materials such as colophonium to allow controlled release of the active substances. Furthermore, the paints may comprise plasticizers, modifiers which affect the rheological properties and other conventional constituents. The active substance combinations according to the invention may also be incorporated into self-polishing antifouling systems.

The positive effect of the active substance combinations according to the invention on the growth of the plant, and the resulting yield gains, can be seen from the example which follows.

### EXAMPLE 1

### Onions

Onions cv. Vaquero from the Dutch company Nunhems were pretreated uniformly with the fungicidal active substances thiram (2 g ai/kg) and carbendazim (1 g ai/kg) by customary methods. Thereafter, the seed was treated as follows, using insecticidal active substances:
1. control, no insecticides
2. Poncho WS 70 (clothianidin) at 0.18 mg ai/seed
3. Gaucho WS 70 (imidacloprid) at 0.18 mg ai/seed
4. clothianidin+imidacloprid at 0.09+0.09 mg ai/seed

The onion yields are shown in Table 1 which follows.

TABLE 1

| | | | Yield in % relative to |
|---|---|---|---|
| | | Application rate | the insecticide- |
| Treatment | Active substances | mg ai/seed | untreated control 1 |
| 1 | — | — | 100 |
| 2 | clothianidin | 0.18 | 137 |
| 3 | imidacloprid | 0.18 | 109 |
| 4 | clothianidin + | 0.09 + | 157 |
| | imidacloprid | 0.09 | |

While the individual active substances clothianidin (variant 2) and imidacloprid (variant 3) already have a growth-promoting effect, the activity of the mixture of imidacloprid and clothianidin (variant 4) exceeds this effect markedly with regard to the yield, while the total application rate is the same.

1. Composition comprising of at least two synergistically active chloronicotinyl insecticides for the treatment of seed, wherein the at least two chloronicotinyl insecticides comprise a mixture selected from the group consisting of:

| Mixture | First active | Second active |
|---|---|---|
| No. | substance | substance |
| 1 | Imidacloprid | clothianidin |
| 2 | Imidacloprid | dinotefuran |
| 3 | Imidacloprid | thiamethoxam |
| 4 | Imidacloprid | thiacloprid |
| 5 | Imidacloprid | acetamiprid |
| 6 | Imidacloprid | nitenpyram |
| 7 | Clothianidin | dinotefuran |
| 8 | Clothianidin | thiamethoxam |
| 9 | Clothianidin | thiacloprid |
| 10 | Clothianidin | acetamiprid |
| 11 | Clothianidin | nitenpyram |
| 12 | Dinotefuran | thiamethoxam |
| 13 | Dinotefuran | thiacloprid |
| 14 | Dinotefuran | acetamiprid |
| 15 | Dinotefuran | nitenpyram |
| 16 | Thiamethoxam | thiacloprid |
| 17 | Thiamethoxam | acetamiprid |
| 18 | Thiamethoxam | nitenpyram |
| 19 | Thiacloprid | acetamiprid |
| 20 | Thiacloprid | nitenpyram |
| 21 | Acetamiprid | nitenpyram |

2. Composition according to claim 1, wherein the two synergistically active chloronicotinyl insecticides comprise the mixtures 1 or 3.

3. Composition according to claim 2, wherein the two synergistically active chloronicotinyl insecticides are imidacloprid and clothianidin.

4. Seed treated with a composition according to claim 1.

5. Transgenic seed treated with a composition according to claim 1.

6. Method of promoting plant growth by treating the seed with a composition according to claim 1.

7. Method of promoting the growth of transgenic plants by treating the seed with a composition according to claim 1.

8. A composition for promoting plant growth comprising a composition according to claim 1.

9. A composition for promoting the growth of transgenic plants comprising a composition of claim 1.

10. Seed treated with a composition according to claim 2.

11. Seed treated with a composition according to claim 3.

12. Transgenic seed treated with a composition according to claim 2.

13. Transgenic seed treated with a composition according to claim 3.

14. Method of promoting plant growth by treating the seed with a composition according to claim 2.

15. Method of promoting plant growth by treating the seed with a composition according to claim 3.

16. Method of promoting the growth of transgenic plants by treating the seed with a composition according to claim 2.

17. Method of promoting the growth of transgenic plants by treating the seed with a composition according to claim 3.

18. A composition for promoting plant growth comprising a composition according to claim 2.

19. A composition for promoting plant growth comprising a composition to according to claim 3.

20. A composition for promoting the growth of transgenic plants comprising a composition of claim 3.
